(19) United States
(12) Patent Application Publication
(10) Pub. No.: US 2025/0322454 A1
(43) Pub. Date: Oct. 16, 2025

(54) ANALYZING A UNIT FOR UPGRADED ACCESS

(71) Applicant: Truist Bank, Charlotte, NC (US)

(72) Inventor: Sara Jeanne Davis, Cookeville, TN (US)

(73) Assignee: Truist Bank, Charlotte, NC (US)

(21) Appl. No.: 18/636,338

(22) Filed: Apr. 16, 2024

(51) Int. Cl. G06Q 40/03; G06Q 40/06

(52) U.S. Cl. CPC G06Q 40/03; G06Q 40/06

(57) ABSTRACT

A framework for client credit authorization level analysis criteria, communication and actions in a digital banking system. A client with past credit problems enters a credit improvement program at a financial institution. The client's financial asset and liability information, along with credit history are provided via the digital banking system. The client identifies objectives, such as paying off debt or qualifying for a car loan. Roadblocks and opportunities are identified from the financial data and the credit history. Goals are programmatically defined based on the client background data, along with a reward to be earned upon achievement of the goals. Conventional algorithms and machine learning techniques may be used for computing the goals and rewards in a manner which is amendable to the client and the financial institution. Progress toward the goals is monitored in the digital banking system, and communications are provided to the client, particularly positive reinforcement messages.

### FIELD

The present disclosure relates generally to the field of digital banking systems, and more particularly to a workflow process, analysis criteria and communication methodology for improving a client's credit standing and authorization level at a financial institutions, including establishment of data-driven goals and rewards, continuous monitoring and forecasting, and implementation of rewards when goals are achieved.

### BACKGROUND

Digital banking systems are well known and used by many bank businesses and their customers. Two common types of digital banking systems are online web-based systems which interact with a user via a web browser window on a computer, and mobile applications (“apps”) which run on mobile devices such as smart phones and tablets. Both online web-based banking systems and mobile banking apps communicate with back-end servers which manage account data, validate and execute specific transactions, provide data for display, etc. Both web-based and mobile app-based systems also include security and customer authentication features, where user-provided information and/or biometric information is collected from the customer and validated with data stored on the back-end server. Digital banking systems, including web-based and mobile app-based systems, are often referred to as online banking systems, which terms will be used interchangeably throughout the present disclosure.

Each customer has one or more accounts with the bank, which the customer may access and manage using the digital banking system. The accounts might include checking and/or savings accounts, credit cards, and possibly investment accounts or others. Customers typically receive periodic statements for each account—such as a monthly credit card statement—in which every transaction is listed (deposits, withdrawals, purchases, payments, etc.) and a new account balance is shown. These statements may be in paper or electronic form.

Digital banking systems also provide access to near-real-time account information, where transactions are posted to the account ledger soon after the transaction's occurrence. For example, a credit card purchase at a coffee shop will often appear in the online transaction list for the credit card account within minutes of the purchase. Digital banking systems are also known to provide other data for customer accounts besides the aforementioned transaction lists. For example, digital banking systems may provide a summary of spending or account balance for recent months, and the systems also typically offer convenience to the customer by way of links to features which customers often use—such as check deposits, money transfers and bill paying.

Even with the data access capabilities of digital banking systems discussed above, some customers end up with a credit situation which is less than desirable—including having a low credit score, carrying large balances of high-interest credit card debt, being declined for loans, and so forth. Credit repair services exist which purport to offer customers a way out of a bad credit situation—but these third-party services have several shortcomings.

For one thing, third-party credit repair services do not have access to all of a customer's financial asset and liability information, and therefore often have to resort to manually collecting information and updating the information periodically. Even then, third-party services do not have access to real-time transaction data which may be helpful in defining a set of credit improvement goals and objectives for a customer. Furthermore, third-party credit repair services often resort to defaulting on payments in an attempt to coerce credit card companies and collection agencies to settle for a fraction of the amount owed by the customer. These default tactics may succeed in reducing the outstanding debt of a customer, but the missed payments and arbitrated settlements are extremely damaging to the customer's credit history and score, which further exacerbates the credit access problem in the future.

In light of the circumstances described above, there is a need for an online banking system which provides proactive features and functions for improving the credit standing of individual customers—including analyzing all available customer financial data, establishment of concrete goals and continuous monitoring of progress.

### BRIEF SUMMARY

The present disclosure describes a framework for client credit authorization level analysis criteria, communication and actions in a digital banking system. A client with past credit problems enters a credit authorization level improvement program at a financial institution. The client's financial asset and liability information, along with credit history and other data are provided via the digital banking system. The client identifies objectives, such as paying off debt or qualifying for a car loan. Roadblocks and opportunities are identified from the financial data and the credit history. Goals are then programmatically defined based on all of the client background data, along with a reward to be earned upon successful achievement of the goals. Conventional algorithm and machine learning techniques may be used for computing the goals and rewards in a manner which is achievable to the client and not overtly risky to the financial institution. Progress toward the goals is monitored automatically in the digital banking system, and communications are provided to the client, particularly including positive reinforcement messages regarding progress. Upon achievement of the goals and delivery of the reward, a next set of goals and a corresponding reward may be defined.

The features, functions, and advantages that have been discussed may be achieved independently in various embodiments of the present disclosure or may be combined in yet other embodiments, further details of which can be seen with reference to the following description and drawings, along with the appended claims.

### BRIEF DESCRIPTION OF THE DRAWINGS

FIG. 1 illustrates an enterprise system, and environment thereof, including a centralized server system, distributed computers and mobile devices, and communication therebetween, according to at least one embodiment of the present disclosure;

FIG. 2 is a simplified illustration of the enterprise system of FIG. 1, showing the elements most directly involved in the communication of a level upgrade to a tiered client account embodied in the present disclosure;

FIG. 3 is a mock-up illustration of a display screen of a computing device running a digital banking application, depicting an account overview including various data displays and insights related to recent activity for a particular account of a user, according to an embodiment of the present disclosure;

FIG. 4 is a mock-up illustration of the digital banking application on the display screen of FIG. 3, depicting a complete user dashboard including the account overview of FIG. 3 along with a financial health section containing various data displays and insights for all accounts of the user of the digital banking application, according to an embodiment of the present disclosure;

FIG. 5 is a mock-up illustration of a display screen on a mobile device, showing a welcome screen of a credit authorization level improvement program including client-selectable objectives, according to an embodiment of the present disclosure;

FIG. 6 is a mock-up illustration of a display screen on the mobile device of FIG. 5, illustrating a communication to the client where credit improvement program goals and rewards are detailed, according to an embodiment of the present disclosure;

FIG. 7 is a mock-up illustration of a display screen on the mobile device, illustrating a communication to the client where progress toward the credit improvement program goals is detailed, according to an embodiment of the present disclosure;

FIG. 8 is a mock-up illustration of a display screen on the mobile device 500, illustrating a communication to the client where goals in the credit improvement program have been achieved, according to an embodiment of the present disclosure; and

FIG. 9 is a flowchart diagram of a method for determining and communicating an authorization level upgrade to a tiered client account, according to an embodiment of the present disclosure.

### DETAILED DESCRIPTION OF EMBODIMENTS

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

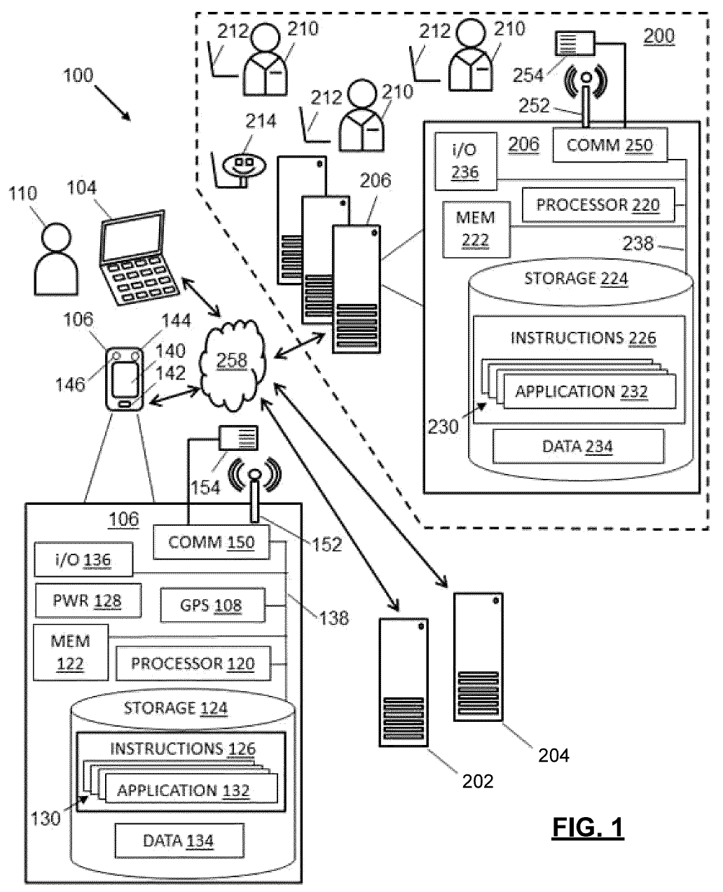

FIG. 1 illustrates a system 100 and environment thereof, including centralized and distributed computing devices, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

One type of algorithm suitable for use in machine learning modules as described herein is an artificial neural network or neural network, taking inspiration from biological neural networks. An artificial neural network can, in a sense, learn to perform tasks by processing examples, without being programmed with any task-specific rules. A neural network generally includes connected units, neurons, or nodes (e.g., connected by synapses) and may allow for the machine learning program to improve performance. A neural network may define a network of functions, which have a graphical relationship. As an example, a feedforward network may be utilized, e.g., an acyclic graph with nodes arranged in layers.

Having described an enterprise computing environment as might be used by a banking business, and general characteristics of systems which may be employed in the enterprise computing environment, attention is now turned to the specific topic of the present disclosure-a framework for client credit authorization level analysis criteria, communication and actions in a digital banking system. This begins with illustrations and discussion of data available to users of digital or online banking systems, and how this data may be employed in pursuit of improved credit standing.

Digital banking systems are well known and used by many bank businesses and their customers, including online web-based systems which interact with a user via a web browser window, and mobile applications (“apps”) which run on mobile devices such as tablets and smart phones. Both online web-based banking systems and mobile banking apps communicate with back-end servers which validate and execute specific transactions, provide data for display, etc.

Banking customers have at least one account, and often more than one account, with a bank business. These accounts may include savings accounts, checking accounts, investment accounts, credit cards, loans, mortgages, etc. Customers receive a statement for each account, typically once per month. The statement lists a beginning balance, all transactions for the statement period, and an ending balance, among other things. Online banking systems (also known as digital banking systems) also typically provide customers with access to near-real-time transaction lists for each account, where transactions appear in the online system as soon as they are posted to the bank's back end database.

In addition, databases are available from third party sources which contain supplemental data related to the transactions in the bank customers' online transaction lists. Other data is also available from third party sources which is either related to activity in a specific customer account or is related to other accounts of the customer, or an overall financial status of the customer. This supplemental data can be integrated with the bank's own transaction data in ways which allow the customer to gain a better understanding of his or her financial situation than any of the individual data sources alone would provide.

Techniques for integrating data from one or more third-party data sources with the bank's own data—including adding new data fields to transaction data records, and selecting data fields from a third-party source to overwrite a common data field of the bank's own data-were disclosed in U.S. patent application Ser. No. 18/154,291, Titled “DATA SOURCE INTEGRATION”, filed on Jan. 13, 2023 and commonly assigned with the present application. The application Ser. No. 18/154,291 is hereby incorporated by reference in its entirety, and will hereinafter be referred to as “the '291 application”.

The techniques of the present disclosure describe methods for providing financial insights in the form of credit improvement opportunities to the customers. This is done by analyzing the available asset, liability and transaction data and defining specific goals and steps for achieving those goals. Further description of the data types and the related analysis techniques are discussed below with respect to the remaining figures.

Despite the availability of online banking systems having many convenient features and including real-time access to account balance and spending data, some customers find themselves in less than desirable credit situations. For example, even though a customer may have a job with a steady income, discretionary spending added on top of rent payments and student loan payments may have caused an accumulation of high-interest credit card debt which the customer cannot pay off. Adding to the problem, the customer may attempt to take a lower-interest loan to pay off the credit card debt, only to be declined for the loan due to a low credit score. The techniques of the present disclosure describe methods for using a financial institution's online banking systems to proactively help customers improve their credit standing—in particular by analyzing the wealth of financial data for each customer and identifying achievable credit improvement goals.

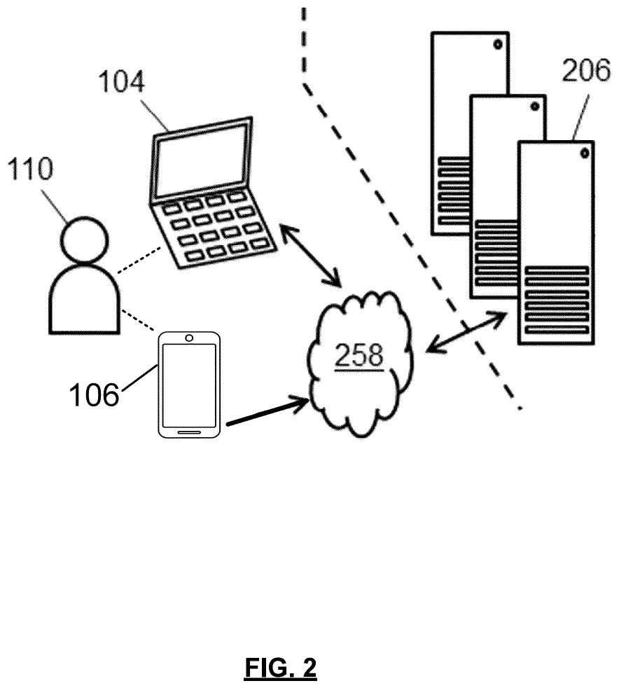

FIG. 2 is a simplified illustration of the enterprise architecture depicted in FIG. 1, showing the elements most directly involved in the methods for establishment of a client credit authorization level improvement program embodied in the present disclosure. The user 110 uses either the computing device 104 or the mobile device 106 to access a digital banking system, where the computing device 104 would run a web browser application in which the digital banking system is displayed, and the mobile device 106 would run a mobile app specifically designed as the digital banking system. The computing device 104 and/or the mobile device 106 communicate with the computing system (back-end servers) 206 via the network (“cloud”) 258. These devices and their usage in the client credit improvement program are depicted below. As understood by those knowledgeable in online banking systems, customers may access their accounts via either mobile app (e.g., on a smart phone) or by a computer-based web browser, or both. As such, the following screens depict some features of the credit authorization level improvement program as they would appear in a mobile app, and some features as they would appear on a computer-based web browser screen.

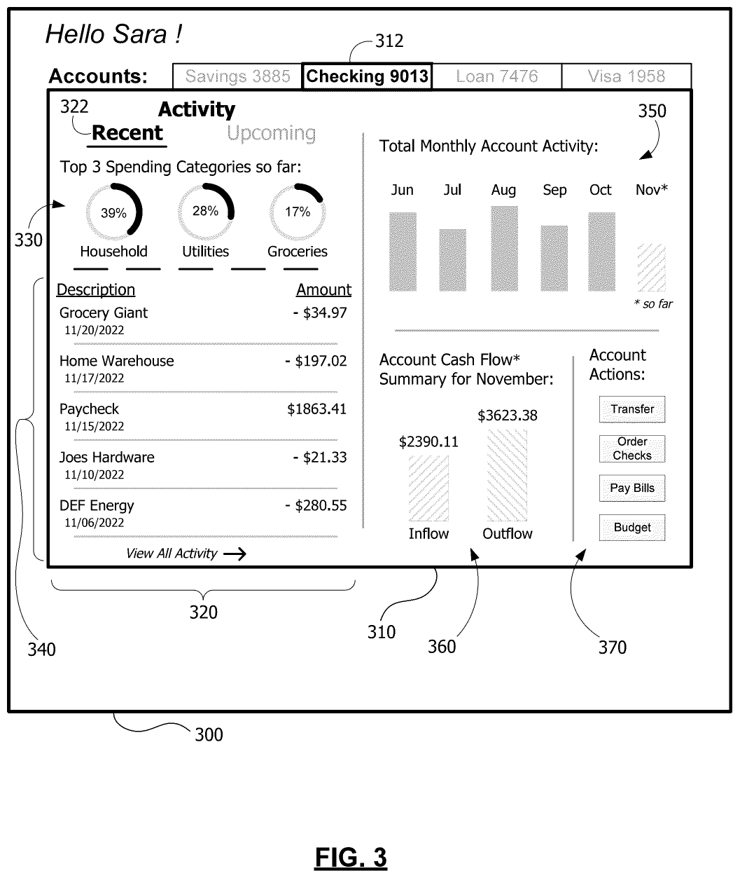

FIG. 3 is a mock-up illustration of a display screen 300 of a computing device running a digital banking application, depicting an account overview including various data displays and insights related to recent activity for a particular account of a user, according to an embodiment of the present disclosure. FIG. 3 provides helpful background by depicting many different types of data that are available to a customer in an online banking system of a financial institutions, where this data is used in building a credit authorization level improvement plan for a customer using the presently disclosed techniques discussed below.

The display screen 300 of FIG. 3 is depicted in a manner which generally corresponds with a computer monitor, where the computer is running a web browser application and the monitor has a large display area. That is, a lot of information can be displayed simultaneously, as shown in FIG. 3 (and later figures). It is to be understood that in other embodiments of the present disclosure, a mobile app is configured to display the same information depicted in FIG. 3; however, because of the smaller screen area of mobile devices (especially smart phones), the data displays may be distributed across multiple pages of the app, where the user navigates the pages using tabs at the top and/or bottom of the screen, or other suitable techniques.

The display screen 300 of FIG. 3 is part of, or communicates with, a computer which corresponds with the computing device 104 of FIGS. 1 and 2. It is to be understood that the computer and display screen 300 of FIG. 3 communicate with a back-end server such as the computing system 206 of FIGS. 1 and 2, by way of communications channels such as WiFi and/or cellular communication networks as illustrated by the network 258 (“the cloud”). In other embodiments, the display screen 300 is the display of the mobile device 106, where the mobile app may format the data differently than shown in FIG. 3 but the same displays and insights are available.

An account overview section 310 includes several data displays and insights in connection with a particular account of the user. If the user has more than one account with the bank, as is often the case, any one of the accounts may be selected using the tabs at the top of the account overview section 310. In FIG. 3, the particular account selected is a checking account ending in the digits 9013, as indicated at 312. Other accounts (not selected)—including a savings account, a loan account and a credit card account—are also shown. The checking account is used as an example in the figures because checking accounts, with associated debit cards, typically see a lot of transactional activity. However, the assets and liabilities of all of the user's accounts are known to the online banking system and used in the credit improvement plan methodology.

On the left side of the account overview section 310 is a transaction section 320. The transaction section 320 allows the user to select a recent transactions view or an upcoming transactions view. In FIG. 3, the Recent transactions view is selected as indicated at 322. Upcoming transactions data may also be available—including things like expected paychecks, upcoming rent payments, forecast utility payments, and the like. Both recent (actual) and upcoming transaction data may be helpful in building a credit improvement plan for a customer.

Near the top of the transaction section 320 is a graphical indicator of the top three spending categories for the account, indicated at arrow 330. Assigning a category (e.g., groceries, entertainment, etc.) to purchase transactions is a common practice, and techniques for allowing the user to reassign the category for individual transactions were discussed in the '291 application. Understanding spending trends by category can therefore be a very useful budgeting and planning tool for consumers.

In one embodiment, the top three spending categories are shown for the current month to date (“so far”), which could be either based on a calendar month or a statement billing cycle month (or user selectable as one or the other). The top three spending categories depicted at 330 are shown as circle graphs where the percentage of spending for transactions in the particular category is displayed as an arc covering a proportional circumference of the circle. In other words, for a category that has a 25% share of the spending, the arc would circumscribe one-quarter of the circle, or 90°. Other types of graphs may also be used to convey the same spending-by-category information to the user. Regardless of the specific graphical format, the display of spending trends by category provides a quick and helpful financial insight to the customer.

Directly below the top spending categories at 330, a transaction list 340 is provided. The transaction list 340 displays a list of transactions (recent transactions in this case), including a description (usually a merchant name for purchases), a transaction date and a transaction amount for each transaction. The transactions are typically listed in chronological order, with the most recent at the top of the list. A link to view all transaction activity is provided at the bottom of the transaction list 340, where the full transaction list would typically be a scrollable list of all transactions in the current billing period (or another selected period), and could contain additional data (such as category) for each transaction. Note that the transaction list includes individual items such as a debit card purchase at the grocery store, and automatic recurring items such as a paycheck deposit and a utility bill electronic fund transfer.

In the upper right of the account overview section 310 is a monthly total section 350. The monthly total section 350 includes a bar chart showing total spending, in the selected account, for the past several months. In one embodiment, the current month spending so far is shown in a bar which has a different color or fill pattern. The monthly total section 350 provides a financial insight to the consumer by way of comparison of spending trends over time.

Below the monthly total section 350 is an account cash flow section 360. In one embodiment, the account cash flow section 360 depicts the cash inflow and outflow for the selected account, for the current month so far, as side-by-side bars with numerical values attached. Other graphical formats may be used as suitable. The account cash flow section 360 provides another important financial insight to the consumer, indicating which direction the account is trending.

To the right of the account cash flow section 360 is an account actions section 370. The account actions section 370 includes buttons or links which the user may click in order to take certain actions—such as transferring funds, ordering checks, paying bills, etc. Other or different actions may be included in the account actions section 370, as would be understood by those familiar with digital banking systems.

The positioning and size/shape of the various sections and displays within the account overview section 310 may of course be changed without departing from the spirit of the present disclosure. Also, as discussed above, the various sections and displays may appear very differently than shown in FIG. 3 on a mobile device such as a smart phone with a small display area. For example, in a mobile app on a smart phone, the transaction section 320 may occupy the entire display screen—and tabs, up and down scrolling and/or left and right swipes may be used to access other sections and data displays.

FIG. 3 illustrates many different types and sources of financial data which may be used in building a credit improvement plan for a customer, as discussed above. In addition, the features and functions of an online banking system of the type shown in FIG. 3 promote engagement of the customer in the understanding and management of his or her financial situation. This engagement helps to discourage the tendency of a customer to want to “bury their head in the sand” when they know their financial situation is not good.

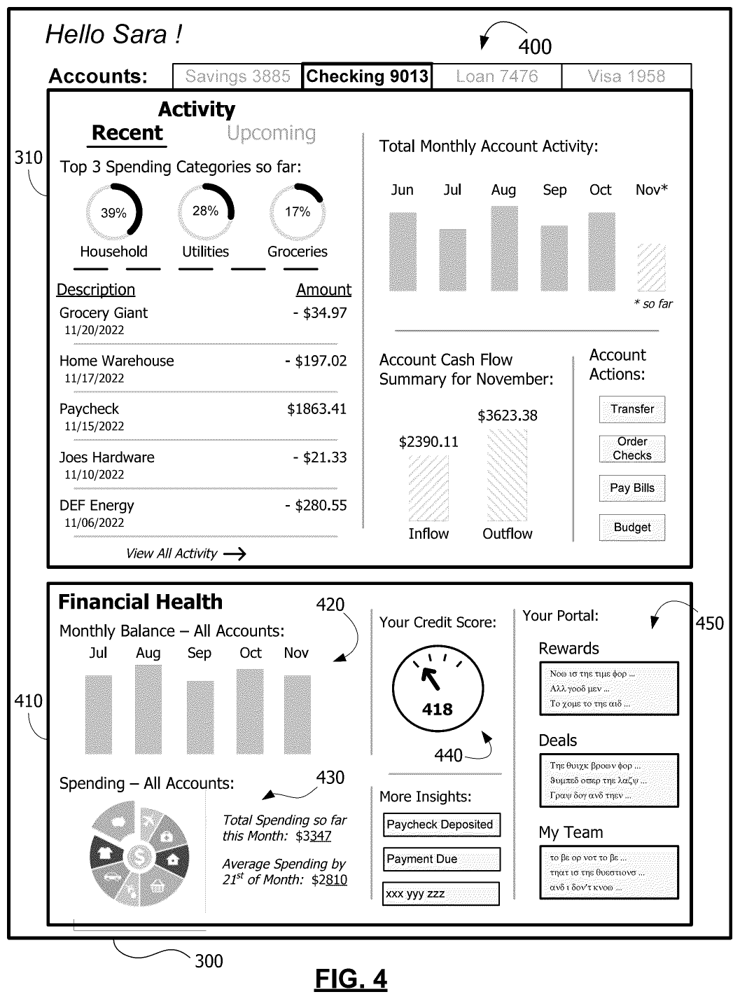

FIG. 4 is a mock-up illustration of the digital banking application on the display screen 300, depicting a complete user dashboard 400 including the account overview of FIG. 3 along with a financial health section containing various data displays and insights for all accounts of the user of the digital banking application, according to an embodiment of the present disclosure. FIG. 4, like the earlier figures, illustrates a large-format display screen such as a computer monitor, where a lot of information can be displayed at once. Once again, all of the information, data displays, graphics and insights depicted in the computer screen format of FIG. 4 are also available in mobile app form (such as on a smart phone).

The dashboard 400 includes the account overview section 310 which provides financial insights in connection with a single account of the user, as discussed in detail above with respect to FIG. 3. The dashboard 400 also includes a financial health section 410 which provides insights into the overall financial picture for the user—including data which is aggregated across multiple accounts, and other information. The information in the financial health section provides a data-based overview of the user's financial situation which can be used as a basis for the credit improvement program techniques discussed below.

The financial health section 410 includes a bar chart depicting the monthly balance for all user accounts over the past several months, as indicated at 420. The monthly balance chart provides the user with a clear and concise understanding of their aggregate account balance over time, which enables insight into any positive or negative trend. By aggregating the balance across all accounts (e.g., savings, checking, investment, etc.), the monthly balance chart eliminates the hassle or guesswork of looking up multiple account balances individually and adding them up. In addition, the monthly balance chart may include data for accounts held at a different financial institution, if the user chooses to make such data available to the digital banking system. The monthly balance data may take some other form besides the bar charts shown in FIG. 4. The monthly balance data may also be shown for credit card accounts, where the credit card balances (liabilities) are shown either separately from or superimposed upon the savings and checking account balances (assets).

Directly below the monthly balance chart is a spending by category chart, as indicated at 430. Like the monthly balance chart discussed above, the spending by category chart reflects all user accounts—including accounts held at different financial institutions if applicable. The spending by category chart may be computed for spending in the current month (calendar or statement), or for a longer period of time (e.g., past six months) selected by the user.

In some embodiments, the spending chart is displayed as a wheel chart or pie chart, with each category occupying a segment of the circle proportional to its percentage of overall spending. Each category (travel, groceries, household, etc.) may preferably be labeled with a simple graphical icon (e.g., an airplane for the travel category). Additional details may be obtained by the user hovering over or clicking on a segment of the spending chart. This could result in a pop-up bubble which lists the category, the total spending in that category, and even a list of transactions included in the category spending.

The spending by category chart derives its data from all applicable user accounts—which could include multiple checking accounts (with debit cards) and multiple credit card accounts. Collecting data from all of these accounts and analyzing it by category of spending provides a tremendous insight for the consumer, whether looking for areas to reduce spending, or simply interested in gaining a better understanding of spending patterns for budgeting purposes. In particular, analysis of discretionary spending in categories such as bars, restaurants and coffee shops may be a useful strategy for establishing a savings plan with a view to improved credit standing.

The financial health section 410 also includes a credit score display 440, depicted here as a meter or gauge with the needle pointing at a position on the gauge corresponding to the user's numerical credit score, which is also displayed inside or near the gauge. The credit score may be obtained from one or more of the credit bureaus, where the displayed credit score is an average when more than one independent credit bureau score is available. Providing the credit score display 440 in the financial health section 410 is a convenience to the user, as the intention of the dashboard 400 is to portray a complete picture of the consumer's financial status, with the ability to dig deeper as desired. Furthermore, the user may gain insight into the change in credit score over time as it correlates with other data on the dashboard 400—such as account balances.

A section 450 is labeled “Your Portal”, and contains buttons or links to other information, features and functions that the user may find convenient. These include things like rewards earned by the user (including rewards associated with achieving credit authorization level improvement goals), deals available to the user (discounts received as a result of various accounts and activities of the user), and a list of contacts which the user may call on for certain information or services—including a personal credit counselor at the financial institution. Other buttons and links may be provided in the section 450, either in place of or in addition to those shown in FIG. 4.

Below the credit score display 540 is a section titled “More Insights”, which includes buttons or links which allow the user to quickly get more information about certain events—such as a paycheck recently deposited, or an upcoming payment due (such as for an auto loan or a credit card). The insights are designed as “teasers” containing few words which the user can parse very quickly, understand the context, and pursue further if interested. Many other such insights may be listed, either in place of or in addition to those shown, and it is envisioned that these insights change automatically based on current events.

In some embodiments, each of the display sections in the dashboard 400 discussed above (e.g., the transaction section 320, the monthly total section 350, the credit score display 440, etc.) is constructed as a “widget”, which can be configured according to each user's preferences—that is, included or not included, and resized and/or repositioned on the dashboard 400.

Furthermore, like the “More Insights” discussed above, most or all of the graphs and charts depicted in FIG. 4 may be configured as teasers, where the user can hover over or click on an item (such as one of the transactions in the transaction list, or one element of a bar graph or chart) to see additional details. In some cases, the additional details are provided in a temporary pop-up bubble, and in other cases clicking to get additional details takes the user to a different web page or app page, preferably with a link to conveniently return to the previous page.

Having described the wealth of data, features and functions generally available to users of the online banking system of the financial institution, depicted in FIGS. 3 and 4, discussion now turns to techniques designed specifically for client credit authorization level analysis and improvement planning.

A first step in the process of improving a customer/client credit standing is acknowledging the need for improvement and initiating the analysis and planning process. This first step could be initiated by the client him or herself, initiated by a human analyst at the financial institution, or triggered by a programmatic analysis of the client's assets, liabilities and credit-related history.

FIG. 5 is a mock-up illustration of a display screen 510 on a mobile device 500, showing a welcome screen of a credit authorization level improvement program including client-selectable objectives, according to an embodiment of the present disclosure. The mobile device 500 of FIG. 5 (and later figures) corresponds with the mobile device 106 in the architecture diagrams of FIGS. 1 and 2. It is to be understood that the mobile device 500 runs a digital banking system mobile application (“app”), and that the mobile device 500 communicates with a back-end server (corresponding with the computing system 206) to access client account data.

In FIG. 5, the digital banking system welcomes the client into the credit authorization level improvement program and prompts the client to identify his or her personal objectives. In some embodiments, these objectives may include one or more of paying off debt (e.g., high interest rate credit cards), improving his or her credit score, and or qualifying for credit instruments such as a mortgage, a car loan or lease, a personal loan (such as to consolidate and pay off higher interest debt), and/or a credit card. These options are shown generally at 520 using checkboxes, indicating that more than one of the options may be selected as illustrated. It should be understood that other credit objectives may be offered, in place of or in addition to those shown in FIG. 5.

There are two significant purposes for the credit improvement objectives identified as shown in FIG. 5. One purpose is simply to get the client engaged in the thought process of improving his or her credit standing. Many people, once they get into a situation where they cannot pay off their credit cards regularly, simply muddle along without addressing the situation-continuing bad spending habits, failing to establish a recover plan, etc. By prompting the client to define objectives, the level of client engagement and commitment to improving his or her credit standing necessarily increases.

A second purpose of the objectives identified as shown in FIG. 5 is to use those objectives in creating a personalized set of goals and corresponding rewards for the client's credit improvement program. This usage of the client credit objectives will be discussed further below.

With the client's credit improvement objectives identified as discussed above, and given the availability of the client's financial picture (assets, debts/liabilities, spending patterns, credit history, etc.) as discussed earlier with respect to FIGS. 3 and 4, a next step in the credit authorization level improvement program is to identify credit improvement roadblocks and opportunities. Typical roadblocks to a client's credit improvement may include carrying balances of high interest credit card debt, missed payments on credit cards, utility bills, car loans or other obligations, instances of “not sufficient funds” (NSF) to cover a debit, excessive spending on certain categories of items, and low account balances. All of these things either cause a downgrade of the client's credit score, or cost the client money which could be better used elsewhere, or both. Credit improvement opportunities to some extent may be the flipside of the roadblocks, where the opportunities may include paying off high-interest debt, and reducing discretionary spending at merchants such as restaurants and coffee shops.

The credit improvement roadblocks and opportunities discussed above may all be determined by programmatic evaluation and analysis of the client's financial picture data. It may be considered beneficial to display the identified roadblocks and opportunities to the client via screens in the digital banking systems (the mobile app or the web-based online banking system). In addition, at this point in the process and/or elsewhere, it may be beneficial to bring a human credit analyst onboard for the client's benefit. The human analyst can explain the identified roadblocks and opportunities to the client in the context of the client's financial picture, discuss next steps in the process, and serve as a mentor and coach for staying on track with financial discipline toward the goals which are established.

With the client's credit improvement objectives identified, along with corresponding credit improvement roadblocks and opportunities, a next step in the credit authorization level improvement program is to identify specific goals toward the credit improvement objective, and one or more rewards which will be delivered upon successful achievement of the goals. Establishment of goals and rewards, along with monitoring of progress toward the goals and communication of that progress, are key elements of the disclosed credit authorization level improvement program. These aspects will be discussed below with respect to the next few figures.

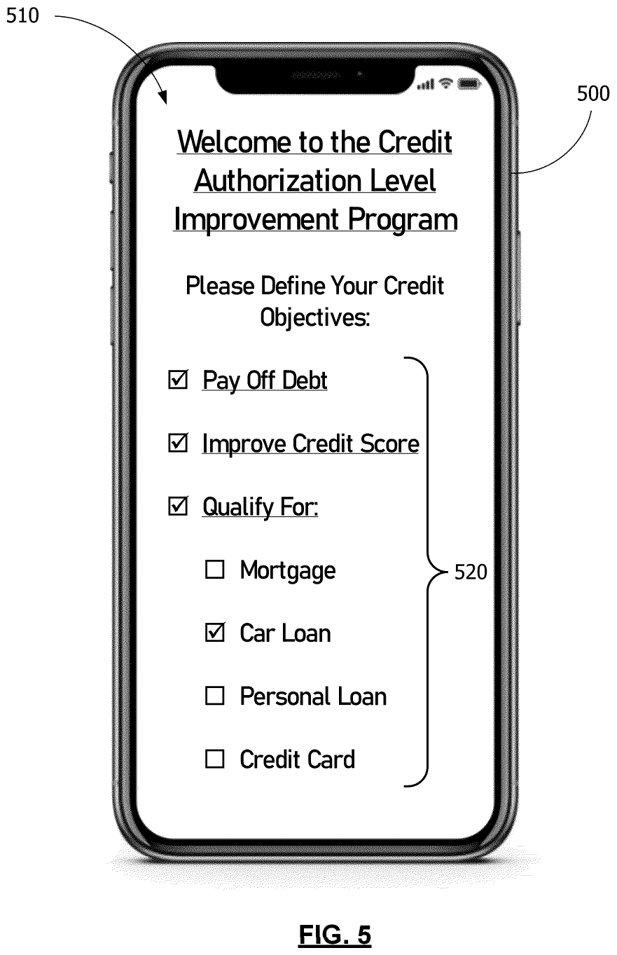

FIG. 6 is a mock-up illustration of a display screen 610 on the mobile device 500 of FIG. 5, illustrating a communication to the client where credit improvement program goals and rewards are detailed, according to an embodiment of the present disclosure. The mobile device 500 depicted in FIG. 6 and later figures was discussed earlier, including a digital banking system mobile app that runs on the mobile device 500, along with the device's communication with a back-end server to access client account data.

In FIG. 6, two goals and a reward have been established for the client, based on the client's financial information, credit history and the objectives defined in an earlier stage of the program. The client's first goal in the credit improvement program is to stay cash flow positive for three months. The second goal is to establish a savings account balance of $2000. Both of these goals require awareness by the client of his or her income and spending habits, and have been established as reasonable and “doable” for the client. Establishing unrealistic goals can have a negative effect on credit behavior. The goals shown in FIG. 6 are both realistic and achievable in a relatively short amount of time.

The reward which has been laid out for delivery upon achievement of the goals is a car lease (or loan) with a payment amount of $500/month. The desire for a car lease or loan was defined earlier in the objectives phase. Thus, the reward offered by the credit improvement program is directly aligned with a desired objective of the client. This alignment also serves to reinforce client financial discipline toward achieving the goals.

The client may have previously been declined for a car loan or lease, even by the very same financial institution which runs the credit improvement program described in the present disclosure. However, by laying out a program of modest goals and a corresponding reward, the financial institution can both protect its own interests (not offering highly risky or bad credit) while also encouraging a client to improve his or her financial picture and credit rating. This illustrates the benefits of the disclosed credit authorization level improvement program to both the financial institution and its clients. Clients who experience the benefit of the credit improvement program are also likely to tell acquaintances about their positive experience, resulting in more clients for the financial institution.

At the bottom of the display screen 610 is a button 612 to take the user to an account home page or financial overview page, similar to the screens shown in FIG. 3 or 4. It is to be understood that the digital banking app and the web-based online banking system of the present disclosure includes all normally-provided features for navigating between different screens, features and functions.

Criteria may be defined for programmatically determining types of goals (e.g., cash flow, balances, discretionary spending, etc.) and corresponding numerical values of the goals, along with associated rewards and amounts, based on each individual client's financial picture (assets, debts/liabilities, spending patterns, credit history, etc.). These criteria may be established by documenting the best practices of the financial institution's credit counselors, loan officers, risk management specialists, etc. As mentioned earlier, while the goals and rewards shown in FIG. 6 may be automatically determined for a particular client based on the client's financial picture, it is also desirable to have a credit counselor working with each client, which provides a built-in mechanism for feedback and adjustment of the criteria for goals and rewards.

Once the goals and rewards have been established as in FIG. 6, another key element of the credit improvement program is monitoring of the client's progress toward the goals and communication of status. In particular, positive reinforcement communication messages can be particularly helpful in motivating a client to maintain discipline and stay on track with the program.

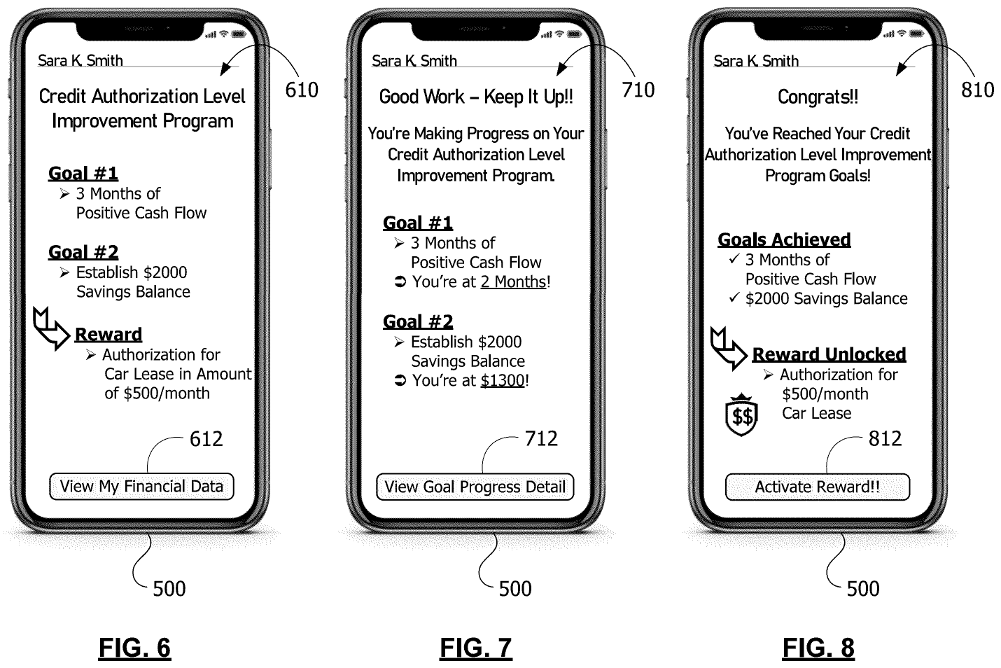

FIG. 7 is a mock-up illustration of a display screen 710 on the mobile device 500, illustrating a communication to the client where progress toward the credit improvement program goals is detailed, according to an embodiment of the present disclosure. In FIG. 7, the client's two goals are displayed along with the progress toward their achievement. The client's first goal in the credit improvement program is to stay cash flow positive for three months as discussed earlier. In FIG. 7, the client learns that he or she has achieved two of the three months. The second goal is to establish a savings account balance of $2000. In FIG. 7, the client learns that he or she has reached a savings balance of $1300.

Both of the goal status updates shown in FIG. 7 represent good and real progress toward the prescribed goals. As such, the display screen 710 may be provided to the user of the digital banking mobile app as a “push notification”—that is, a small pop-up bubble which appears on the mobile device and which identifies the app (the digital banking system) and the gist of the notification (e.g., “Goal Progress”). As known to users of mobile devices and apps, the user can then touch the push notification pop-up bubble and the digital banking system app will launch on the mobile device, and the details of the screen 710 will be displayed. Using push notifications—particularly in the case of a good news communication—is an effective means of providing positive reinforcement to a client without requiring the client to continuously launch the digital banking system app to check for status.

At the bottom of the display screen 710 is a button 712 to take the user to an app page where details of the goal progress are viewable. For example, this may be a page or screen where graphs of cash flow and savings balance over time are displayed. Other types of data displays may be envisioned in support of the client's understanding of goal progress, and may be accessed via the button 712.

FIG. 8 is a mock-up illustration of a display screen 810 on the mobile device 500, illustrating a communication to the client where goals in the credit improvement program have been achieved, according to an embodiment of the present disclosure. In FIG. 8, the client's two goals are displayed along with indication of their achievement. As a result of the achievement of the goals, the display screen 810 confirms to the client that the reward (associated with the goals, as explained earlier) has been unlocked or awarded. Again, the display screen 810 may be provided to the user of the digital banking mobile app as a push notification—so that the goal achievement and reward delivery are immediately communicated to the client.

At the bottom of the display screen 810 is a button 812 to take the user to an app page where the reward may be “activated” or collected. In this example, the button 812 may take the user to an app page where the loan or lease authorization is officially documented. Furthermore, the app may trigger the release of funds to an automotive dealership—either at the very moment of the reward activation if a car loan or lease contract has already been drawn up, or later at such a time as the vehicle is selected and the contract is drawn up.

The display screens of FIGS. 6-8 are merely exemplary; many other types and formats of display screens depicting similar features and functions may be envisioned within the scope of the present disclosure. Furthermore, the particular goals and rewards shown in FIGS. 6-8 are also merely exemplary, and many other types of goals and corresponding rewards may be envisioned, as discussed earlier.

The techniques described above—particularly the determination of objective goals and rewards based on the client's financial picture, credit history and other factors—may be embodied in one or more suitable algorithm. Specifically, the determination of goals and rewards may be performed in an algorithm with explicitly defined formula, equations, criteria and logic—where the calculations and logic are formulated based on best practices and experiences defined by financial institution personnel. Alternately, the determination of goals and rewards may be performed in a machine learning system such as a neural network which learns—through unsupervised learning, supervised learning or a combination thereof—to associate certain features of a client's financial picture and credit history with favorable outcomes. Recurrent training of the machine learning system can be performed as clients proceed through the credit improvement/authorization level upgrade program and their actual inputs and outputs are used as training samples.

Additionally, it should be noted that the techniques depicted in the drawing figures and discussed above may be applied most generally to the delivery of any type of advantage (“reward”) based on achievement of any defined set of criteria (“goals”), based on factors such as personal objectives of a client, business and fiduciary objectives and responsibilities of a financial institution, and so forth. The advantages/rewards and criteria/goals may be determined using complex algorithms and/or machine learning systems including neural networks, evaluating volumes of data and complex interactions of the factors in a manner which could not possibly be performed by a person or a team of people in their head or using a pencil and paper.

It is also noted that the generalized system architecture includes a server computer which may be any type of computer providing multi-user access, including multi-processor and parallel-processing servers, computers particularly optimized for running neural network systems, etc. The server computer communicates with a “unit” which is generally a user operating a user device such as a smart phone or a tablet device running an app, or a personal computer running a web browser.

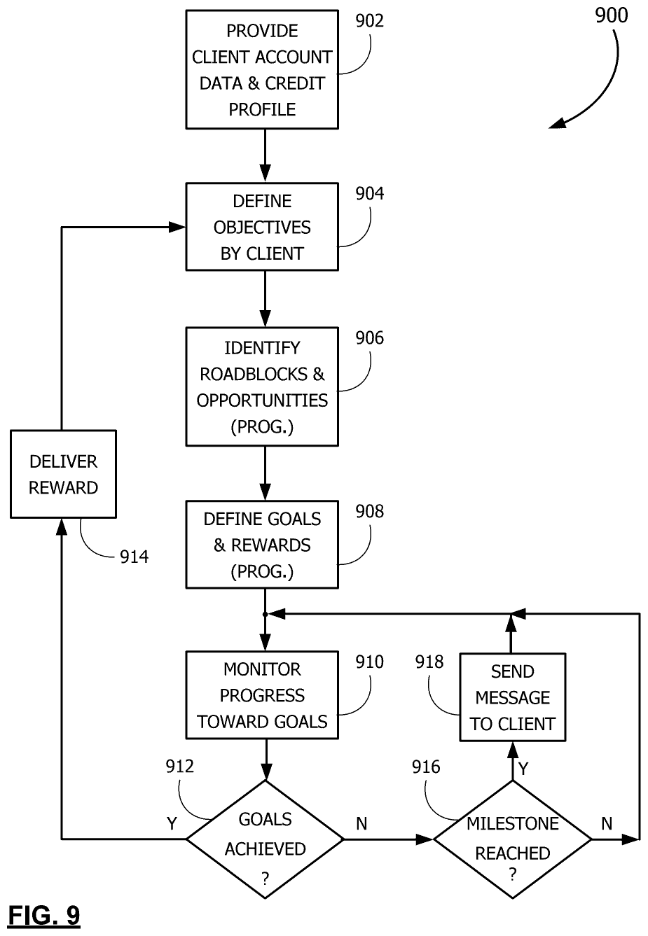

FIG. 9 is a flowchart diagram 900 of a method for determining and communicating an authorization level upgrade to a tiered client account, according to an embodiment of the present disclosure. At box 902, a client's complete financial picture and credit profile are provided. This is as depicted in FIGS. 3 and 4 discussed earlier, where the client has one or more accounts in a digital banking system of a financial institutions, and the account data, data such as transaction detail from supplemental sources, and credit history information are all provided in the digital banking system. The understanding is that the client wishes to participate in a credit improvement program with the financial institution, according to the techniques disclosed herein.

At box 904, objectives for the credit improvement program participation are identified by the client. This was depicted in FIG. 5 discussed earlier, where the objectives include one or more things such as paying off debt, improving the client's credit score, or qualifying for a new line of credit which could be a mortgage, an auto loan or lease, a personal loan or a credit card. As discussed earlier, the client may have recently had a similar application for credit declined, even by the same financial institutions. However, by entering a structured credit improvement program, it is expected that a better outcome can be achieved.

At box 906, roadblocks and opportunities for the client's credit improvement are identified. The roadblocks and opportunities are determined programmatically by one or more algorithm in the digital banking systems. This includes analysis of the client account data and credit profile provided at the box 902—for example, identification of missed or late payments on credit cards or loans, negative cash flow, low savings balance, and other factors. The roadblocks and opportunities, in addition to being used in the determination of goals and rewards, may be communicated to the client via an app screen or web page in the digital/online banking system.

At box 908, objective goals for the client's credit improvement are defined, along with at least one reward for achieving the goals. The goals and rewards are also determined programmatically by one or more algorithm in the digital banking systems. This includes analysis of the client account data and credit profile provided at the box 902, along with the objectives identified by the client at the box 904. The determination of goals and rewards may be a complicated computation because it needs to strike a balance between at least three criteria. A first criteria is that the defined reward must be valuable enough to the client that it is worth some sacrifice to achieve. For example, if the promised reward is a car loan, then the client may decide that it's worth foregoing a five-dollar cup of coffee every morning and a few restaurant meals. A second criteria is that the defined goals must be realistically achievable to the client in the short to medium term. In other words, there's no point in telling a client that he/she must save up $50,000 before the financial institution will consider offering a loan. A third criteria is that the promised reward must not be overly risky to the financial interests of the institution. That is, the financial institution wants to offer a car loan that the client is likely to be able to repay—not a loan that the client is likely to default on.

As explained above, the determination of the goals and rewards at the box 908 may be computed either using an algorithm with explicitly defined formula, equations, criteria and logic, or the determination of goals and rewards may be performed in a machine learning system such as a neural network which learns to associate certain features of a client's financial picture and credit history with favorable outcomes.

The goals and rewards determined at the box 908 are also communicated to the client via an app screen or web page in the digital/online banking system. An example of this was depicted in FIG. 6.

At box 910, progress toward the goals is monitored by an algorithm in the digital banking system. This includes monitoring statistics like balances on outstanding debt, bill payment history, cash flow, savings balances, and so forth. At decision diamond 912, it is determined whether the defined goals have been achieved. If so, then at box 914 the reward(s) is/are delivered to the client as promised. An example of this was depicted in FIG. 8, where a push notification (or equivalent type of message) is displayed to the client indicating that the goals have been achieved, and providing a link to an app page where the reward may be obtained. Following delivery of the reward at the box 914, the process returns to the box 904 where the objectives may be reevaluated (as one or more may have been met, and one or more new ones may be apparent), and the process continues as long as the client wishes to remain in the credit improvement program.

If, at the decision diamond 912, the goals have not been achieved, then at decision diamond 916 it is determined whether a milestone has been reached toward the goals. If so, then at box 918 a message is sent to the client as a means of positive reinforcement, listing the goals and the progress toward their achievement. An example of this was depicted in FIG. 7. Following sending the message at the box 918, the process returns to the box 910 to continue monitoring progress. If, at the decision diamond 916, no milestone has been reached, then the process returns to the box 910 to continue monitoring progress.

The client authorization level upgrade criteria, communication and actions methodology, discussed above, provides advantages to both clients and the financial institution which employs the program. Clients are provided with an opportunity to get their credit back on track, and see the results of their efforts in terms of positive reinforcement messages and rewards for goal achievement. The financial institution not only manages the risk associated with such clients, but also creates tremendous customer loyalty from clients who have a positive experience with the authorization level upgrade program.

Particular embodiments and features of the disclosed methods and systems have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A method for analyzing a unit for upgraded access, said method comprising:
providing a source of data to a server computer having a processor and memory;
identifying one or more objectives for the potential upgraded access, by a unit communicating with the server computer;
determining an advantage in the form of the upgraded access, along with one or more criteria which must be achieved in order to obtain the advantage, by the server computer, including analyzing the data and the objectives;
monitoring progress toward the criteria, by the server computer, using updated values from the source of data; and
delivering the advantage to the unit when the one or more criteria are achieved.

2. The method according to claim 1 wherein the unit is a user operating a user device, where the user device is one or more of a tablet device or a smart phone configured with a mobile application which communicates with the server computer, and/or a personal computing device configured with a web browser application which communicates with the server computer.

3. The method according to claim 2 wherein the data includes financial data for one or more accounts of a client of a bank who is the user, the data further including a credit history for the client, and where the advantage is a reward in the form of an approved authorization level for the client, and the criteria are goals.

4. The method according to claim 3 wherein the objectives include one or more of paying off debt, improving a credit score, or qualifying for a mortgage, a car loan or lease, a personal loan or a credit card.

5. The method according to claim 3 wherein the goals include one or more of on-time payment percentage for existing credit, paying off or paying down existing credit, a savings balance exceeding a computed savings threshold, a cash flow exceeding a cash flow threshold amount and time duration, an improvement in a credit score, and a reduction in spending in one or more categories of discretionary spending as indicated by a transaction history.

6. The method according to claim 5 wherein the reward is selected from a group comprising approval of a mortgage, approval of a car loan or lease, approval of a new credit card, approval of a credit limit for an existing credit card, and approval of a personal loan.

7. The method according to claim 6 wherein the goals and the reward are determined based on input elements including the financial data for the client, the credit history for the client, and the objectives defined by the client, and the input elements are evaluated against factors defined in a group consisting of a reward desirability factor for the client, a goal achievability factor for the client, and a financial risk management factor for the bank.

8. The method according to claim 7 wherein the goals and the reward are computed using an algorithm including mathematical calculations and logic based on the input elements and the factors.

9. The method according to claim 7 wherein the goals and the reward are computed using a machine learning system including a neural network which forms nodal and layer connections based on the input elements, the factors, the goals and the reward.

10. The method according to claim 9 wherein the neural network is initially trained using a supervised learning process with pre-classified client data examples including the input elements, manually determined goals and reward, and an actual outcome classified as favorable or unfavorable, and the neural network is subsequently trained using a supervised learning update training process with supplemental client data examples including the input elements, the goals and the reward previously determined by the neural network, and an actual outcome classified as favorable or unfavorable.

11. The method according to claim 1 further comprising determining whether a milestone toward the criteria has been reached and, when a milestone has been reached, sending a communication to the unit providing notification of the milestone.

12. A method for determining an authorization level upgrade, said method comprising:
providing a source of data to a server computer having a processor and memory, where the data includes financial data for one or more accounts of a client of a bank, and the data further includes a credit history for the client;
identifying one or more objectives for the credit authorization level upgrade, by the client on a user device communicating with the server computer;
determining a reward in the form of a credit authorization level upgrade, along with one or more goals which must be achieved in order to obtain the reward, by the server computer, including analyzing the data and the objectives, where the goals include one or more of on-time payment percentage for existing credit, paying off or paying down existing credit, a savings balance exceeding a computed savings threshold, a cash flow exceeding a cash flow threshold amount and time duration, an improvement in a credit score, and a reduction in spending in one or more categories of discretionary spending as indicated by a transaction history, and the reward is selected from a group comprising approval of a mortgage, approval of a car loan or lease, approval of a new credit card, approval of a credit limit for an existing credit card, and approval of a personal loan;
monitoring progress toward the goals, by the server computer, using updated values from the source of data; and
delivering the reward to the user when the one or more goals are achieved.

13. A system for determining an authorization level upgrade, said system comprising:
one or more user devices; and
a server computer in communication with the user devices and having at least one processor and memory,
where the server computer is configured for;
reading a source of data, where the data includes financial data for one or more accounts of the client of a bank, and the data further includes a credit history for the client;
receiving one or more objectives for the credit authorization level upgrade, provided by the client on one of the user devices;
determining a reward in the form of a credit authorization level upgrade, along with one or more goals which must be achieved in order to obtain the reward, by the server computer, including analyzing the data and the objectives;
monitoring progress toward the goals, by the server computer, using updated values from the source of data; and
delivering the reward to the user when the one or more goals are achieved.

14. The system according to claim 13 wherein the user device is one or more of a tablet device or a smart phone configured with a mobile application which communicates with the server computer, and/or a personal computing device configured with a web browser application which communicates with the server computer.

15. The system according to claim 13 wherein the objectives include one or more of paying off debt, improving a credit score, or qualifying for a mortgage, a car loan or lease, a personal loan or a credit card.

16. The system according to claim 13 wherein the goals include one or more of on-time payment percentage for existing credit, paying off or paying down existing credit, a savings balance exceeding a computed savings threshold, a cash flow exceeding a cash flow threshold amount and time duration, an improvement in a credit score, and a reduction in spending in one or more categories of discretionary spending as indicated by a transaction history, and where the reward is selected from a group comprising approval of a mortgage, approval of a car loan or lease, approval of a new credit card, approval of a credit limit for an existing credit card, and approval of a personal loan.

17. The system according to claim 16 wherein the goals and the reward are determined based on input factors including the financial data for the client, the credit history for the client, and the objectives defined by the client, and the input factors are evaluated against criteria defined in a group consisting of a reward desirability factor for the client, a goal achievability factor for the client, and a financial risk management factor for the bank.

18. The system according to claim 17 wherein the goals and the reward are computed using an algorithm including calculations and logic based on the input factors and the criteria.

19. The system according to claim 17 wherein the goals and the reward are computed using a machine learning system including a neural network which forms nodal and layer connections based on the input factors, the criteria, the goals and the reward.

20. The system according to claim 19 wherein the neural network is initially trained using a supervised learning process with pre-classified client data examples including the input factors, manually determined goals and reward, and an actual outcome classified as favorable or unfavorable, and the neural network is subsequently trained using a supervised learning update training process with supplemental client data examples including the input factors, the goals and the reward previously determined by the neural network, and an actual outcome classified as favorable or unfavorable.
